(19) United States
(12) Patent Application Publication
(10) Pub. No.: US 2008/0144131 A1
(43) Pub. Date: Jun. 19, 2008

(54) IMAGE FORMING APPARATUS AND METHOD OF CONTROLLING THE SAME

(75) Inventors: Eun Young Jung, Suwon-si (KR); Jae Ho Kim, Suwon-si (KR); Sook Hyun Kong, Hwaseong-si (KR); Won Young Chi, Suwon-si (KR); Yoon Yi, Suwon-si (KR); Sung Hyur Ryu, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/948,003

(22) Filed: Nov. 30, 2007

(30) Foreign Application Priority Data
Dec. 14, 2006 (KR) 2006-128049

(51) Int. Cl. H04N 1/04

(52) U.S. Cl. 358/474

(57) ABSTRACT

An image forming apparatus includes a scan unit, a handwriting determining unit, a corresponding image detection unit, a storage unit, a print unit and a controller. In an extraction copy mode, the image formation apparatus scans an original document and detects handwriting marks of a user, extracts original document images of portions of the original document identified by handwriting marks from the scanned images, and stores and prints the original document images. Therefore, a user who only wants to copy portions of a document does not have to cut up and re-paste the document. In a clean copy mode, the image forming apparatus scans the original document to provide scanned images, detects the handwriting marks of the user in the scanned images, extracts clean original document images from which the handwriting marks are removed, and stores and prints the clean original document images. Therefore, a clean copy of a document that has been marked on can be obtained without having to physically remove the markings from the document.

### CROSS-REFERENCE TO RELATED APPLICATIONS

This application claims the benefit of Korean Application No. 2006-128049, filed Dec. 14, 2006, in the Korean Intellectual Property Office, the disclosure of which is incorporated herein by reference.

### BACKGROUND OF THE INVENTION

1. Field of the Invention

Aspects of the present invention relate generally to an image forming apparatus, and more particularly to an image forming apparatus that is capable of distinguishing original document images from handwritten markings added to the original document by a user in the images obtained by scanning the original document and a method of controlling the same.

2. Description of the Related Art

Typically, in order to extract various parts (such as desired passages) from specific teaching materials and books and to create a new document, a user cuts out the parts to be extracted from the specific teaching materials and books, attaches or pastes the cut-out parts into the new document, and scans and prints the new document.

However, in such a method, since the user must cut and paste the parts to be extracted, the method is complicated, takes a long time, and causes inconvenience to the user.

Also, if the user has scribbled or made written notes or underlinings in the parts of a document to be extracted, then even when the parts of the document that the user wishes to include in the new document are cut and pasted into the new document, and the obtained new document is scanned and printed, the scanned document includes both the original document images and the scribbled notes and markings, and a clean scanned document cannot be produced unless the scribbled notes and markings can be erased from the original document.

### SUMMARY OF THE INVENTION

Accordingly, aspects of the present invention provide an image forming apparatus in which a user can easily and rapidly extract and print portions of an original document without having to cut up the document.

According to an embodiment of the present invention, there is provided a method of controlling an image forming apparatus, the method comprising: scanning a document; detecting handwriting marks from the scanned document; extracting an original document image of a portion of the scanned document from which the handwriting marks are detected; and storing the extracted original document image.

According to an aspect of the present invention, the portion of the scanned document in which the handwriting marks are detected comprises at least one of an underlined part in the document, handwriting letters and a highlighted part.

According to an aspect of the present invention, the method further comprises printing the stored original document image.

According to an aspect of the present invention, in the printing of the original document image, when a plurality of stored original document images exists, an original document image selected by a user is printed.

According to an aspect of the present invention, in the printing of the original document image, when a plurality of stored original document images exist, the stored original document images are printed according to a preset print arrangement order or a print arrangement order input by a user.

According to another aspect of the present invention, there is provided a method of controlling an image forming apparatus, the method comprising the steps of: scanning a document; detecting handwriting marks in the scanned document; extracting an original image of the document from which the handwriting marks are removed; and storing the extracted original image.

According to another aspect of the present invention, there is provided an image forming apparatus comprising: a scan unit that scans a document; a handwriting determining unit that detects handwriting marks included in the scanned document; an extracting unit that extracts an original document image of a portion of the scanned document in which the handwriting marks are detected; a storage unit that stores the extracted original document image; a print unit that prints the stored original document image; and a controller that controls operations of the scan unit, the handwriting determining unit, the extracting unit, the storage unit and the print unit.

According to an aspect of the present invention, the handwriting determining unit detects the handwriting marks from the scanned document by detecting pixel patterns in the handwriting marks that are different from pixel patterns of the original document image having no handwriting marks.

According to an embodiment of the present invention, there is provided an image forming apparatus comprising: a scan unit that scans a document; a handwriting determining unit that detects handwriting marks included in the scanned document; an extracting unit that extracts an original document image of the scanned document from which the handwriting marks are removed; a storage unit that stores the extracted original document image; a print unit that prints the stored original document image; and a controller that controls operations of the scan unit, the handwriting determining unit, the extracting unit, the storage unit and the print unit.

According to another embodiment of the present invention, there is provided an image forming apparatus comprising an operation panel unit that receives a command input selecting an extraction copy mode or a clean copy mode of the image forming apparatus; a scan unit that scans an original document; a handwriting determining unit that detects handwriting marks included in the scanned document; a extracting unit; a storage unit; a print unit; and a controller that receives the command input from the operation panel unit and controls the scan unit, the handwriting determining unit, the extracting unit, the storage unit and the print unit such that if a command input received by the operation panel unit selects the extraction copy mode, the extracting unit extracts an original document image of a portion of the original document identified by handwriting marks of the user, the storage unit stores the extracted original document images and the print unit performs printing of the stored extracted original document images, and if the command input received by the operation panel unit selects the clean copy mode, the extracting unit extracts an original document image of the scanned document from which the handwriting marks of the user have been removed, the storage unit stores the extracted original document image; and the print unit performs printing of the stored extracted clean original document image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic representation of an image forming apparatus according to an embodiment of the present invention;

FIG. 2 is a schematic block diagram of the image forming apparatus of FIG. 1;

FIG. 3 is a flowchart of an operation of the image forming apparatus according to an embodiment of the present invention;

FIG. 4 is an example of an original document in which specific parts are underlined and highlighted by a user, the document being an original document upon which the operations of FIG. 3 may be performed;

FIG. 5 illustrates a printed material obtained by an operation according to FIG. 3, wherein only images of the underlined and colored parts of the original document of FIG. 4 are printed; and

FIG. 6 illustrates a printed material obtained by an operation according to FIG. 3 wherein only the image of the original document of FIG. 4 is printed underlining or highlighting markings are removed.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, exemplary embodiments of the present invention will be described with reference to the accompanying drawings.

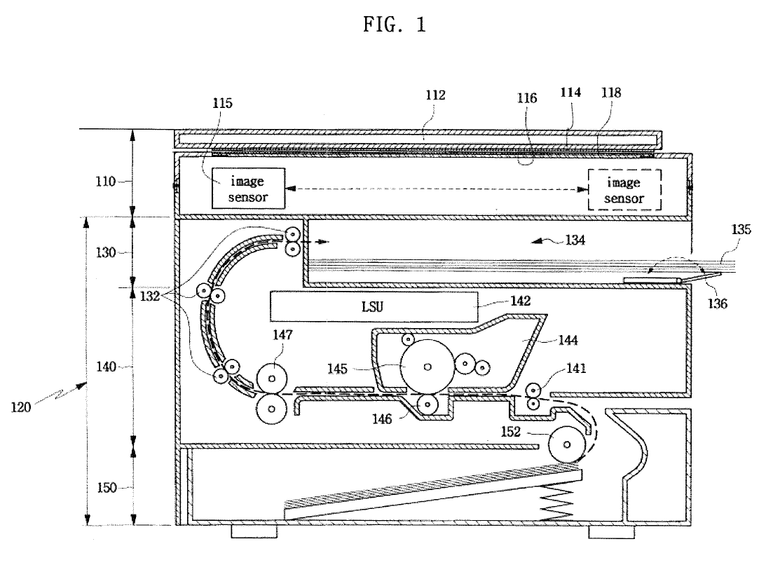

FIG. 1 is a schematic representation of an image forming apparatus according to an embodiment of the present invention. Referring to FIG. 1, the image forming apparatus includes a scan unit 110 on an upper side of the image forming apparatus that scans images in a document 118. The image forming apparatus further includes a print unit 120 on the lower side of the image forming apparatus that prints the scanned images onto a sheet 135.

The scan unit 110 includes a document holder 114 in which a space is provided, a glass 116 that is provided on the document holder 114 and on whose top the document 118 to be read is placed, a platen cover 112 provided to press the placed document 118, and an image sensor 115 that reciprocates from side to side in a predetermined period under the glass 116 to read the images formed in the document 118. As non-limiting examples, a CMOS image sensor (CIS) and a charge coupled device (CCD) can be used as the image sensor 115. The image sensor 115 converts an optical signal into an electrical signal so that the read images can be printed by a print unit 120.

The print unit 120 includes a main body in which a sheet transferring path is provided so that a scanned image is transferred onto a sheet. The print unit 120 includes a sheet storage unit 150 that supplies the sheet to the main body thereof, a printing unit 140 that prints images on the transferred sheet, and an output unit 130 provided to discharge the sheet on which images are printed to the outside. The printing unit 140 receives images from the scan unit 110 to form the images on the sheet and to fix the images to the sheet. The printing unit 140 includes a photosensitive body 145 provided to be rotatable, a laser scanning unit (LSU) 142 that receives images from the scan unit 110 to form the images on the photosensitive body 145 as electrostatic latent images, a developing unit 144 that converts the electrostatic latent images formed by the LSU 142 into visible images using a toner, a transferring unit 146 that transfers the developed images to the sheet, and a fixing unit 147 that applies heat and pressure to the sheet so that the transferred images are fixed.

The output unit 130 outputs the sheet 135 on which images are formed and includes an output member 136 that supports the outputted sheets 135.

The operation of the image forming apparatus having the above structure will be described as follows. First, in order to copy the document 118, when the document 118 is mounted on the glass 116, the platen cover 112 is closed, a required number of sheets are provided, copying conditions are set, and a copy start key is pressed, the image sensor 115 that is the reading unit of the scan unit 110 reads the content of the document 118 in accordance with the optical energy density, converts the content of the document 118 into an electrical signal, and transmits the electrical signal to a controller that controls the image forming apparatus. The controller transmits a copy command to the LSU 142 in accordance with the signal to start exposure on the photosensitive body 145.

After latent images are formed on the photosensitive body 145 by exposure, a toner of fine powder is transferred to the photosensitive body 145 between the developing roller of the developing unit 144 and the photosensitive body 145. The toner is transferred by high pressure onto a sheet that moves through the transferring unit 146 to complete the transferring process.

Then, the fixing unit 147 fixes the fine toner to the sheet by high temperature heat and high pressure, and the sheet 135 is discharged to an output storage unit 134 provided between the scan unit 110 and the print unit 120 through the output rollers 132.

The sheet storage unit 150 may store a plurality of sheets. The sheets are separated one by one by the pickup roller 152 to be transferred to the transferring unit 146 through a transferring roller 141.

It is to be understood that an image forming apparatus may contain less or more of the features described above and that the physical location and arrangement of the described features can be different from what is shown and described. In particular, any scan unit and print engine unit can be used in an image forming apparatus according to aspects of the present invention.

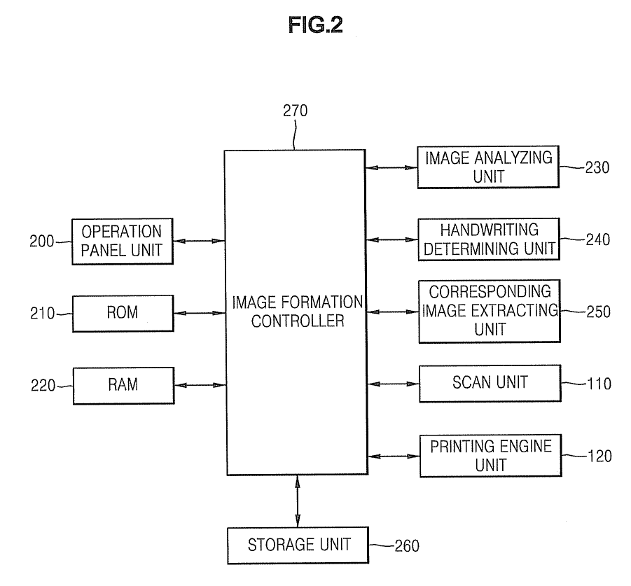

FIG. 2 is a schematic block diagram of the image forming apparatus of FIG. 1. Referring to FIG. 2, the image forming apparatus according to the embodiment of the present invention includes the scan unit 110, the print unit 120, an operation panel unit 200, a random only memory (ROM) 210, a random access memory (RAM) 220, an image analyzing unit 230, a handwriting determining unit 240, an extracting unit 250, a storage unit 260, and a controller 270.

The operation panel unit 200 includes an operation panel to transmit a command of a user to the controller 270 and a liquid crystal display (LCD) panel to display the state of the image forming apparatus in accordance with a control signal of the controller 270.

The ROM 210 is a non-volatile memory in which stored contents are maintained even when the power of the image forming apparatus is cut off. A control program such as an operating system (OS) required for realizing the function of the image forming apparatus is stored in the ROM 210.

The RAM 220 is a volatile memory in which various data items generated during the execution of the corresponding program are stored.

The image analyzing unit 230 analyzes the images scanned by the scan unit 110.

The handwriting determining unit 240 detects characters written by the user and underlinings and highlighting made by a marker pen that are included in the scanned images. The handwriting determining unit 240 uses a handwriting determining algorithm applied to the image analyzing result obtained by the image analyzing unit 230. For example, the pixel pattern of underlined or highlighted parts is different from the pixel pattern of the parts that are not underlined or highlighted. That is, since continuous gray patterns are sensed in the pixel pattern of the underlined and highlighted parts unlike in the pixel pattern of the parts that are not underlined and colored, the handwriting marks are detected based on the above. Also, a hand-marked region can be indicated by specific handwriting notations. For example, the words “start” and “end” or other identifying words or symbols may be used as marks that represent the start and end of a selected region. As used herein, the term “handwriting marks” refers to any marks made by hand on a document, including underlining, highlighting, words, symbols, scribblings, doodles, etc., or combinations of any of these. As used herein, the term “highlighting” refers to any form of marking using a colored pen or highlighter that colors or adds shading to a portion of a document.

The extracting unit 250 extracts the original document images corresponding to the parts determined as containing handwriting marks by the handwriting determining unit 240. For example, when the copy mode to be described later is an extraction copy mode, the original document images of the parts of the document that are underlined and highlighted by a marker pen are extracted. Also, the original document images of the parts of the document corresponding to a hand-marked region represented by specific handwritten words or characters are extracted. As used herein, the term “original document images” refers to the scanned content of an original document as the document would look without the presence of handwriting marks. On the other hand, when the copy mode is a clean copy mode, after removing the handwriting marks of the user such as underlining and highlighting from the entire scanned images, the clean original document images representing the entire document are extracted.

The storage unit 260 stores the original document images extracted by the extracting unit 250.

The controller 270 controls the entire operation of the image forming apparatus. In particular, the controller 270 controls a scanning operation by the scan unit 110 in accordance with a command of the user that is input by the operation panel unit 200. Also, the controller 270 controls the operation of analyzing the pixels and density of the images scanned by the scan unit 110 performed by the image analyzing unit 230. Also, the controller 270 controls the operation of detecting handwriting marks included in the scanned images based on the image analyzing result obtained by the image analyzing unit 230 through the handwriting determining unit 240. Also, the controller 270 controls the operation of extracting the original document images of the parts corresponding to the handwriting marks detected by the handwriting determining unit 240 through the extracting unit 250 when the copy mode is an extracting copy mode of extracting parts from the scanned images. Also, the controller 270 controls the operation of extracting the clean original document images from which the handwriting marks detected by the handwriting determining unit 240 are removed through the extracting unit 250 when the copy mode is a clean copy mode of obtaining the clean original document images by removing the handwriting marks of the user from the scanned images. Also, the controller 270 controls the operation of printing the original document images stored in the storage unit 260 through the print unit 120.

Therefore, according to aspects of the present invention, a user does not need to directly cut out the parts of a document that the user wants to be extracted but only has to underline and/or highlight the parts to be extracted with a marker pen or to write down specific handwritten characters, words or symbols in the parts to be extracted and to input a scan command for extraction. Then, the image forming apparatus automatically determines the parts of the document to be extracted, extracts and stores the original document images corresponding to the determined parts to be extracted, from which the markings have been removed, and prints the extracted parts so that it is possible to easily and rapidly extract and print the original document images of the extracted parts without having to cut up the document. As described below, the printer may print the extracted parts consecutively or in any order.

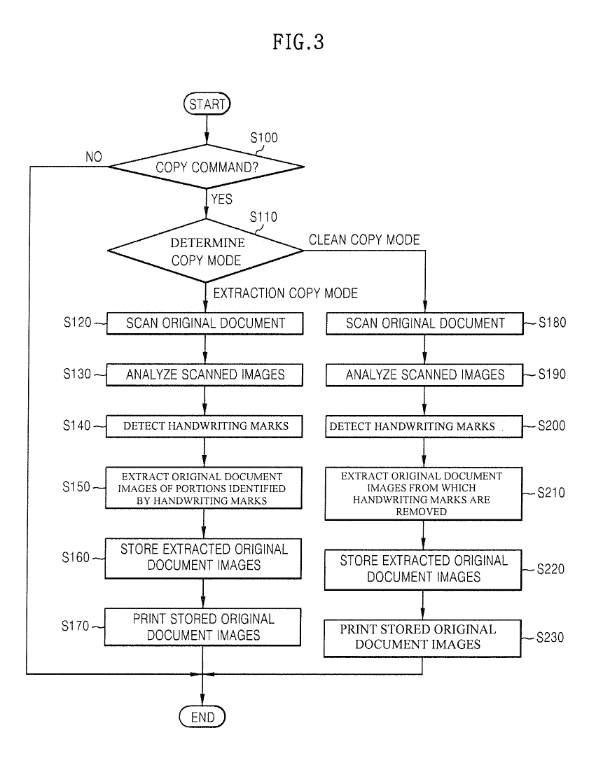

FIG. 3 is a flowchart of an operation of the image forming apparatus according to an embodiment of the present invention. Referring to FIG. 3, first, the controller 270 determines whether a command of the user input by the operation panel unit 200 is a copy command. If it is determined that the command is a copy command, it is determined in S110 whether the copy mode is the extraction copy mode or the clean copy mode.

If it is determined in S110 that the copy mode is the extraction copy mode, the original document is scanned by the scan unit 110 in S120. The images scanned by the scan unit 110 are analyzed by the image analyzing unit 230 in S130.

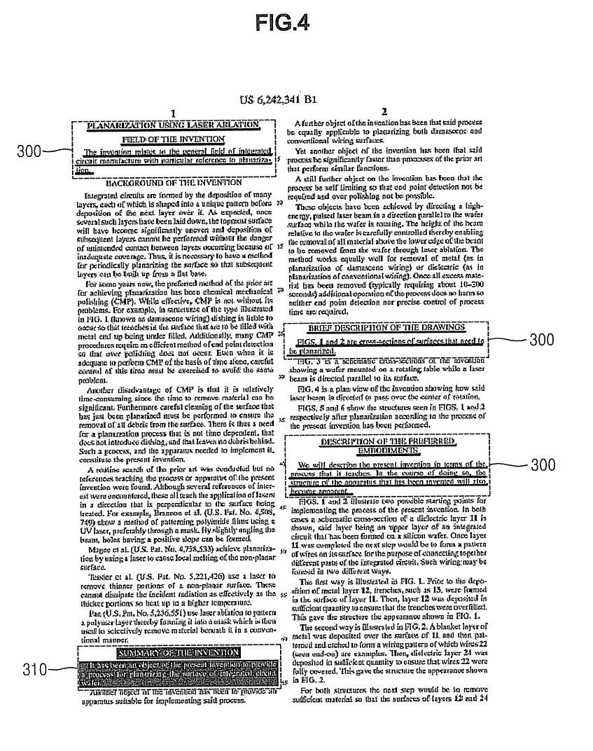

After analyzing the scanned images, the handwriting marks included in the scanned images are detected by the handwriting determining unit 240 using the analyzing result obtained by the image analyzing unit 230 in S140. FIG. 4 is an example of a document in which parts of the document are underlined and highlighted by a marker pen. The underlined parts are “PLANARIZATION USING LASER ABLATION”, “FIELD OF THE INVENTION”, “The invention . . . planarization.”, “BRIEF DESCRIPTION OF THE DRAWINGS”, “FIGS. 1 and 2˜to be planarized.”, “DESCRIPTION OF THE PREFERRED EMBODIMENTS”, and “We will . . . become apparent.” The parts highlighted by a marker pen are “SUMMARY OF THE INVENTION” and “It has . . . circuit wafer.”

After the handwriting marks are detected, the original document images of the hand-marked parts are extracted in S150. As illustrated in FIG. 4, the original document images of the underlined parts of the document, specifically, “PLANARIZATION USING LASER ABLATION”, “FIELD OF THE INVENTION”, “The invention . . . planarization.”, “BRIEF DESCRIPTION OF THE DRAWINGS”, “FIGS. 1 and 2 . . . to be planarized.”, “DESCRIPTION OF THE PREFERRED EMBODIMENTS”, and “We will . . . become apparent.,” are extracted and the original document images of the highlighted parts of the document, specifically “SUMMARY OF THE INVENTION” and “It has . . . circuit wafer.,” are extracted.

After extracting the original document images of the hand-marked parts, the extracted original document images are stored in the storage unit 260 in SI 60.

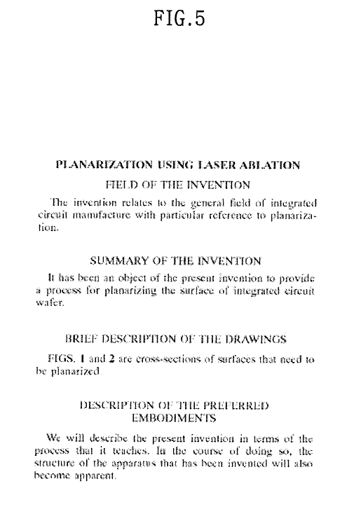

The original document images stored in the storage unit 260 are printed on the sheet in S170. Therefore, as illustrated in FIG. 5, only the original document images corresponding to the underlined and highlighted parts of FIG. 4 are printed. At this time, among the original document images stored in the storage unit 260, only the original document images selected by the user will be printed. As shown in FIG. 5, the original document images may be grouped together and printed without blank spaces between the original document images. Also, the printing arrangement order of the original document images stored in the storage unit 260 can be previously set or the printing arrangement order can be additionally received by the user.

On the other hand, if it is determined in S110 that the copy mode is the clean copy mode, the original document is scanned by the scan unit 110 in S180 and the images scanned by the scan unit 110 are analyzed by the image analyzing unit 230 in S190.

After analyzing the scanned images, the handwriting marks included in the scanned images are detected by the handwriting determining unit 240 using the analyzing result obtained by the image analyzing unit 230 in S200. The clean original document images from which the handwriting marks of the user, such as underlining and highlighting, are removed are extracted from the scanned images in S210.

After extracting the clean original document images from which the handwriting marks of the user are removed, the extracted original document images, referred to herein as the “clean original document images” are stored in the storage unit 260 in S220.

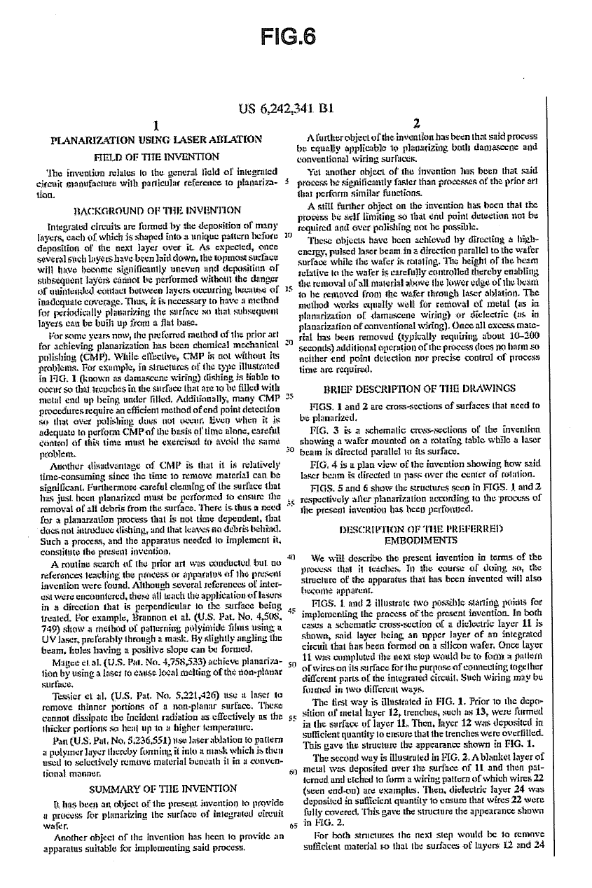

Then, the clean original document images stored in the storage unit 260 are printed on the sheet in S230. Accordingly, as illustrated in FIG. 6, among the scanned images, only the clean original document images from which the underlining and highlighting of FIG. 4 are removed are printed on the sheet.

Therefore, in the case where it is desired to extract specific parts from specific teaching materials and books, when the specific parts are underlined or highlighted by a marker pen, the image forming apparatus automatically detects the specific parts and extracts and prints only the original document images corresponding to the specific parts. For example, in the case of creating institute testing materials, when it is assumed that questions are extracted from various exercise books, a user only has to underline and/or highlight the specific parts of the exercise books that the user wants to have copied. Then, the image forming apparatus automatically detects and extracts the underlined and highlighted parts of the document and collectively prints original document images corresponding to the underlined and highlighted parts so that it is possible to easily create testing materials.

As another example, if memorable sentences are underlined after reading a book or if confusing words are underlined during the studying of a language, the image forming apparatus automatically detects and extracts the underlined sentences and words and collectively prints the underlined sentences and words. Therefore, it is possible to easily create collections of memorable sentences or vocabulary words.

As another example, when lecture notes damaged by handwriting marks are to be copied, the image forming apparatus can print the original document images from which the handwriting marks are removed. Therefore, a user does not need to remove the handwriting marks in order to obtain a clean copy of the lecture notes.

As described above, according to aspects of the present invention, after detecting the handwriting marks of the user in scanned images, in an extraction copy mode, only the original document images of the selected parts of the document designated by the handwriting marks are extracted, stored, and printed. Therefore, the user does not need to cut out the parts to be extracted from books and teaching materials but only has to underline and/or highlight the desired parts with a marker pen, and the image forming apparatus according to aspects of the present invention automatically extracts and prints the desired parts of the document. As a result, it is possible to improve convenience of the user.

Also, according to aspects of the present invention, after detecting the handwriting marks of the user in the scanned images, in a clean copy mode, only the clean original document images from which the handwriting marks are removed are extracted, stored, and printed. Therefore, when lecture notes damaged by handwriting marks are copied, it is possible to print the clean original document images although the handwriting marks are not physically removed from the notes. As a result, it is possible to improve convenience of the user.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling an image forming apparatus, the method comprising:
scanning a document;
detecting handwriting marks from the scanned document;
extracting an original document image of a portion of the scanned document on which the handwriting marks are detected; and
storing the extracted original document image.

2. The method as claimed in claim 1, wherein the portion of the scanned document in which the handwriting marks are detected comprises at least one of an underlined portion of the document, handwriting letters and a highlighted portion of the document.

3. The method as claimed in claim 1, further comprising printing the stored original document image.

4. The method as claimed in claim 3, wherein, in the printing of the original document image, when a plurality of stored original document images exist, an original document image selected by a user is printed.

5. The method as claimed in claim 3, wherein, in the printing of the original document image, when a plurality of stored original document images exist, the stored original document images are printed according to a preset print arrangement order or a print arrangement order input by a user.

6. A method of controlling an image forming apparatus, the method comprising:
scanning a document;
detecting handwriting marks in the scanned document;
extracting an original image of the scanned document from which the handwriting marks are removed; and
storing the extracted original image.

7. The method as claimed in claim 6, wherein the handwriting mark comprises at least one of underlining, handwriting letters and highlighting.

8. An image forming apparatus comprising:
a scan unit that scans a document;
a handwriting determining unit that detects handwriting marks included in the scanned document;
an extracting unit that extracts an original document image of a portion of the scanned document in which the handwriting marks are detected;
a storage unit that stores the extracted original document image;
a print unit that prints the stored original document image; and
a controller that controls an operation of the scan unit that scans the document, an operation of the handwriting determining unit that detects the handwriting marks of the user, an operation of the extracting unit that extracts the original document image of the part from which the handwriting marks are detected in the scanned document, an operation of the storage unit that stores the extracted original document image, and an operation of the print unit that prints the stored original document image.

9. The image forming apparatus as claimed in claim 8, wherein the handwriting determining unit detects the handwriting marks from the scanned document by detecting pixel patterns in the handwriting marks that are different from pixel patterns of the original document image having no handwriting marks.

10. The image forming apparatus as claimed in claim 8, wherein the portion of the scanned document in which the handwriting marks are detected comprises at least one of an underlined part in the document, handwriting letters and a highlighted part.

11. The image forming apparatus as claimed in claim 10, wherein, when a plurality of original document images are stored in the storage unit, the controller controls a print operation according to an original document image selected by a user.

12. The image forming apparatus as claimed in claim 10, wherein, when a plurality of original document images are stored in the storage unit, the controller controls a print operation according to a preset print arrangement order or a print arrangement order input by a user.

13. An image forming apparatus comprising:
a scan unit that scans a document;
a handwriting determining unit that detects handwriting marks included in the scanned document;
an extracting unit that extracts an original document image of the entire scanned document from which the handwriting marks are removed;
a storage unit that stores the extracted original document image;
a print unit that prints the stored original document image; and
a controller that controls an operation of the scan unit that scans the document, an operation of the handwriting determining unit that detects the handwriting marks of the user, an operation of the extracting unit that extracts the original document image of the scanned document from which the handwriting marks are removed, an operation of the storage unit that stores the extracted original document image, and an operation of the print unit that prints the stored original document image.

14. The image forming apparatus as claimed in claim 13, wherein the handwriting determining unit detects the handwriting marks from the scanned document by detecting pixel patterns in the handwriting marks that are different from pixel patterns of the original document image having no handwriting marks.

15. The image forming apparatus as claimed in claim 13, wherein the handwriting marks comprise at least one of underlining, handwriting letters and highlighting.
